(19) United States
(12) Patent Application Publication
(10) Pub. No.: US 2014/0269862 A1
(43) Pub. Date: Sep. 18, 2014

(54) WIRELESS ANTENNA SYSTEM

(71) Applicant: OPTION NV, Leuven (BE)

(72) Inventors: Aleksander Krewski, Mainz (DE); Werner Schroeder, Wiesbaden (DE); Jan Vercruysse, Blanden (BE)

(73) Assignee: OPTION NV, Leuven (BE)

(21) Appl. No.: 14/353,555

(22) PCT Filed: Oct. 23, 2012
(86) PCT No.: PCT/EP2012/070974

§ 371 Date: Apr. 23, 2014

(30) Foreign Application Priority Data
Oct. 23, 2011 (EP) 11186274.4

(51) Int. Cl. H04L 27/26

(52) U.S. Cl. CPC H04L 27/2626; H04L 27/2647
USPC 375/219

(57) ABSTRACT

A wireless antenna system for a terminal comprises an antenna structure and frontend ports for connecting to transmit and/or receive circuitry of the terminal. The antenna system is operable in a first radiation mode and a second radiation mode, wherein the modes are orthogonal. The circuitry is arranged to map the first feed port to the antenna structure for the first radiation mode across a first frequency band having a bandwidth which covers one of an uplink frequency band and a downlink frequency band of the transmit/receive circuitry. The circuitry is arranged to map the second feed port to the antenna structure for the second radiation mode across a second frequency band, wherein the second frequency band covers both of an uplink frequency band of the transmit/receive circuitry and a downlink frequency band of the transmit/receive circuitry. The above concepts are extendible to more than two modes.

### FIELD OF THE INVENTION

This invention relates to a wireless antenna system which is suitable for multiple input-multiple output (MIMO) operation and to a method of using the antenna system as well as to devices including such antenna systems. Further the invention relates to design methods, the related design software related thereto and operating software for the above systems.

### BACKGROUND OF THE INVENTION

Multiple Input-Multiple Output (MIMO) transmission modes are a feature of many wireless communication systems. They are used in wireless communication standards such as Evolved Universal Terrestrial Radio Access (E-UTRA), Long Term Evolution (LTE), Worldwide Interoperability for Microwave Access (WiMAX) and High-Speed Packet Access (HSPA) and are also used in Wireless Local Area Network (WLAN) communications and in other applications. Explanations of MIMO transmission modes can be found in “Introduction to space-time wireless communications” by Paulraj et.al, ISBN 0 521 82615 2.

So as to support MIMO transmission modes such as Receive Diversity (RD) and Spatial Multiplexing (SM), a mobile terminal or wireless modem is equipped with at least two antennas, providing a two port antenna system, and in the general case a multi-port antenna which is designed to receive (or transmit, respectively) signals from different ports independently of each other in the same frequency band. For receive mode “independently” means that the different ports of the multiport antennas are capable of receiving different superpositions of incoming multi-path components which requires that their polarimetric complex radiation patterns are sufficiently distinct. A quantitative measure of this capability is the correlation between signals received at different antenna ports in a given reference propagation scenario.

An often applied metric is the Complex Envelope Correlation Coefficient (CECC) between two antenna signals in the isotropic Rayleigh propagation scenario. Due to the principle of reciprocity which applies to antennas the statements apply analogously to transmit mode operation.

A performance metric of an antenna for a mobile terminal or wireless modem is its bandwidth at a given desired frequency of operation. Other metrics like radiation efficiency are for physical reasons strongly correlated with bandwidth (provided that good engineering practices are applied). The bandwidth of an antenna is physically limited by its size. If the physical size of an antenna becomes much smaller than the free-space wavelength of an electromagnetic wave at the frequency of operation, the bandwidth of an antenna decreases roughly in proportion to the third power of its largest dimension. For a multiport antenna for MIMO transmission, the smallest bandwidth seen at any of its ports will limit the MIMO operation.

The performance of wireless modems is heavily depending on the notion of antenna matching. A single antenna is usually referred to as matched if the return loss (RL) seen into its feed port is large enough for the intended use over the desired bandwidth, ideally it would be infinite. A RL of at least 10 dB is usually considered as acceptable, but smaller levels, down to, say, 6 dB are often accepted in consumer devices as the result of a trade-off between antenna performance and other design goals (e.g. miniaturization). The usable bandwidth is correspondingly the bandwidth where the RL criterion is satisfied. An appropriate metric for an N-port MIMO antenna to be matched over a desired bandwidth is the Total Multi-port Return Loss (TMRL) as defined in: W. L. Schroeder and A. Krewski, “Total Multi-Port Return Loss as Figure of Merit for MIMO Antenna Systems,” in 40th European Microwave Conference, Paper EuMC/EuWiT01-5, Paris, 2010. Ideally, as for RL, TMRL would be infinite indicating zero reflection from at all feed ports and at the same time perfect isolation between all feed ports. This ideal condition is equivalent to Hermitian match of the N×N impedance matrix of the N-port antenna to the N×N impedance matrix of the load. In reality, over a finite bandwidth, this ideal situation cannot be obtained. An acceptable level of TMRL must be defined for a design, similar to the single antenna case. Also, analogously to the single antenna case, the usable MIMO bandwidth of the N-port antenna is the bandwidth over which the selected TMRL level is reached.

Any reasonably designed N-port antenna has N distinct radiation patterns, in the sense that excitation at only one of its ports will result in a different, linearly independent radiation pattern. This is true for each of the ports. Mathematically a unique set of N different superpositions of the N feed port signals exist, which provides N mutually orthogonal radiation patterns and is obtained by eigenvalue decomposition of the radiation matrix whose definition can also be found in the above cited reference. This set of patterns represents the eigenmodes of the N-port antenna, which we refer to as radiation modes of the N-port antenna in the sequel. With every radiation mode can be associated a modal return loss, defined by the ratio of power reflected from all ports over the incident power carried by the unique vector of excitation signals which excites exclusively the radiation mode under consideration. Generally, the network properties of an N-port antenna can be described with respect to its N physical feed ports or with respect to N fictitious ports each of which represents one of the N orthogonal eigenvectors as excitation of the physical ports. The latter case only amounts to a change of the basis of representation. The TMRL criterion for matching can likewise be applied based on the evaluation of the N×N scattering matrix of the antenna with respect to its N physical feed ports or based on evaluation of the N×N scattering matrix with respect to the N-vectors (eigenvectors) of feed port signals which correspond to the N orthogonal radiation patterns. In the idealization of a lossless N-port antenna, the radiation modes coincide with the network modes, i.e. with the eigenvectors of the product of the Hermitian transpose of the scattering matrix with the scattering matrix itself. The latter statement typically holds as a good approximation for real N-port antennas.

In the context of mobile terminals and wireless modems, the largest dimension is to be understood as the largest dimension of the combined arrangement of the nominal antenna and the conductive structure of the device (e.g. mobile phone or laptop) to which it is attached and on which a current density may be excited by the antenna (transmit mode) or to whose excitation by an incoming electromagnetic wave it couples (receive mode). This coupling between antenna and conductive chassis is necessary for many practical small mobile devices as the antennas would not otherwise provide the required bandwidth. The exploitation of the conductive chassis of a mobile device as an antenna extension can be described as the excitation of characteristic modes of the chassis. The radiation pattern of the antenna—chassis combination is given by the respective characteristic modes. So as to achieve the above mentioned “independency” between multiple antenna ports in a MIMO antenna system for a mobile terminal or wireless modem, different superpositions of characteristics modes must be excited (transmit mode) by different antenna ports. This is relatively easy to achieve if the structure is “large” (at the order of half a wavelength) in at least two dimensions and if antenna elements can be spaced at sufficiently “large” distances along the periphery of the conductive chassis. Unfortunately, this is not the case for small size wireless modems such as those realised in Express Card format or in the form of a Universal Serial Bus (USB) dongle attached to a laptop, particularly at frequencies below 1 GHz. In particular it turns out that the required instantaneous bandwidth for MIMO coverage of low-frequency E-UTRA band classes is not attainable within the physical size of an Express Card or USB stick.

For the realisation of efficient multi-port antenna systems in such devices it is therefore mandatory for a second or further antenna ports to extend the volume over the limits of an Express Card or USB stick. Unfortunately, this approach leads to bulky devices and is in conflict with customer expectations and typical use cases for mobile devices such as use of a laptop in a train.

The problem was less severe in the past when multiport antenna systems in mobile devices were predominantly designed for frequencies of operation near 2 GHz.

It is a more severe problem now as frequency bands in the range from 698 MHz to 960 MHz are employed for MIMO transmission.

In some MIMO devices, only a single antenna is integrated within the wireless modem and an external connector is foreseen to attach a second antenna. This solution must be rated as extremely inconvenient from a user's point of view since they have to carry and assemble additional equipment.

### SUMMARY OF THE INVENTION

An object of the present invention is to provide an alternative wireless antenna system which is suitable for multiple input-multiple output (MIMO) operation and a method of using the antenna system as well as to devices including such antenna systems.

A first aspect of the present invention provides an antenna system according to any of the claims 1 to 26.

A second aspect of the present invention provides a terminal according to claim 27.

A third aspect of the present invention provides method of operating an antenna system (and related operating software) according to claims 28 to 31.

A fourth aspect of the present invention provides an antenna system according to any of the claims 32 to 41.

A fifth aspect of the present invention provides a terminal according to claim 42.

A sixth aspect of the present invention provides method of operating an antenna system (and related operating software) according to any of the claims 43 to 49.

A seventh aspect of the present invention provides an antenna system (and related terminal) according to any of the claims 50 to 55.

An eight aspect of the present invention relates to computer implemented design methods, computer program product comprising code segments that when executed on a suitable processing engine implement the steps of such design methods and a machine readable signal storage medium, storing the computer program product, in particular those being adapted to store descriptions of any of the antenna systems or terminals having such systems or a smartphone, a laptop, a tablet, a PDA, a mobile phone having such systems, and being capable to perform one or more of the functions of mapping or designing in accordance with multiple matching criterions or both in accordance with the methods described above.

The antenna system has an advantage of providing radiation pattern diversity and polarisation selectivity, radiation modes which can allow effective multiple port MIMO operation on over a frequency band.

The level of TMRL which can be attained over a desired bandwidth or, conversely, the bandwidth over which a desired level of TMRL can be obtained, is influenced by all N radiation modes of the N-port antenna. Since the Total Multiport Reflectance (the negative logarithm of which yields TMRL) corresponds to a root-mean-square value of the individual reflectances of all radiation modes, the mode with the highest reflectance (smallest modal Return Loss (RL)) governs the TMRL level and, consequently limits the usable MIMO bandwidth. A typical situation which is observed in practical designs is that a first subset of M<N out of the N radiation modes of an N-port antenna can be matched to the desired level of TMRL (evaluated with respect to this subset of only M radiation modes) over the required bandwidth, whereas it is impossible to match all N radiation modes to the same desired level of TMRL (evaluated with respect to all N modes) over the required bandwidth due to fundamental physical limits which apply as a consequence of size restrictions imposed on the design.

One important aspect of the present invention is a novel approach to matching which can be applied either alone or in connection with the novel method of operation in which N-antenna MIMO operation is applied only over a smaller bandwidth, the novel method of operation being in agreement with typical requirements found in mobile communication systems as pointed out later. Whereas in the conventional design of a MIMO N-port antenna, attempt is made to match with respect to all ports (in the sense of maximization of TMRL or minimization of the norm of the N-port scattering matrix) which is equivalent to match with respect to all modes over a required bandwidth, the present invention applies a mode-specific and frequency-selective matching concept. The corresponding matching circuitry is referred to as a mode matching network (MMN). Therefore the invention defines two or more matching criteria to be exploited for groupings of the two or more radiations modes on either a group per group basis or some criteria are used for multiple of such groups, whereby the portions of the spectrum are used in the criteria definitions, again either with entirely different portions or with partially or entirely overlapping portions. The use of a design approach jointly on over all antennas (instead of a per antenna approach) with the above split criteria approach results in new designs and mappings, suitable to obtain the wanted performance for each of the operation modes of the systems (instead of overdesigning).

As an example following the present invention, a subset of M₁<N of the radiation modes can be matched over a first bandwidth B₁, centred about a first centre frequency f₁, and a second autonomous (different but not necessarily disjunctive) subset M₂<=N can be matched over a second bandwidth B₂, centred about a second centre frequency f₂, where the TMRL criterion is applied in either case relative only to the subset of radiation modes under consideration and where the levels of TMRL which are considered as requirement in either case may be the same or may be different. Hence as part of this invention the TMRL is broadened as a criterion. The TMRL accounts not only, as the original definition stipulates, for all radiation modes and for all desired frequency bands of the terminal, but as well for a subset M of radiation modes and/or for a smaller number of frequency bands.

In case of a two-port MIMO antenna, and possible embodiment, a physical antenna structure with two feed ports is considered for connecting to ‘transmit and/or receive circuitry’ of the terminal. Such antenna has N=2 radiation modes (eigenmodes). As a first subset of M₁=1<N=2 radiation modes one may select the set which only contains the first mode. As the second subset of M₂=2<=N=2 radiation modes one may then select the set which comprises both modes. In general the two radiation modes will expose different modal return loss and different bandwidth as a consequence of design constraints. For purpose of illustration we assume here that the usable bandwidth of the second mode is smaller than the usable bandwidth of the first mode. A particular embodiment which is referred to here as example only because of its simplicity is a two-port antenna which is symmetric with respect to its two feed ports, i.e. exposes mirror symmetry with respect to a plane. In this case the two radiation modes correspond to the common and the differential operating mode of the structure. The above referenced first radiation mode may then for instance be identified with the common mode and the second radiation mode with the differential mode.

The MIMO bandwidth which can be attained for the second subset (both modes) under the TMRL criterion is under the above stated assumption therefore smaller than the bandwidth which can be attained for the first subset (first mode only). Advantageously, as part of the present invention, the second subset of modes would be matched over a smaller portion of the frequency band under consideration where MIMO operation is considered indispensable for this smaller portion, whereas the first subset would be matched simultaneously also over an additional portion of the frequency band where MIMO operation is not required. The matching criterion for the second subset of radiation modes and applied only to the smaller portion of the frequency band is TMRL. The same matching criterion is also applied to the first subset of radiation modes but exclusively over the other portion of the frequency band. In the present example, where the first subset contains only a single radiation mode, TMRL coincides with modal RL.

For any wireless system and terminal thereof the downlink (DL) reception is done in the DL band and the uplink (UL) transmission is done in the UL band. It is to be considered for these UL and DL bands are individual spectrum portions. For the GSM900 system it is common the UL and DL band will form one portion of spectrum.

So, in the case of the geometric 2-port-antenna structure symmetry, the common mode is then used for both downlink and uplink transmission whereas the differential mode is used only for one, either uplink or downlink transmission. Thus it is possible to provide MIMO functionality for one of the transmission directions, in connection with the other parts of this invention described further below, at a time without the need for a physically larger antenna system or additional equipment, which would normally be required if the antenna system were to support MIMO operation over the range of frequency bands used for both transmission directions.

Due to geometric and size constraints which are typical for commercial small designs as e.g. datacards, dongles or handsets, the radiation quality factors associated with the two modes are usually different. The radiation quality factor is defined as the ratio of radiated power per cycle of the signal over the average of energy stored in the reactive near field of the antenna arrangement. The common mode can often effectively couple to the conductive chassis of the device. The surface current density on the conductive chassis such excited can then contribute to radiation. This amounts to an effective enlargement of the radiating structure for the common mode. The attainable matched bandwidth is inversely proportional to the radiation quality factor. Consequently the useful bandwidth for the common mode is usually larger. This is the typical case but the opposite case is possible. Reference to the common and differential modes of a geometrically symmetric two-port antenna is made here only for illustration purposes.

Wireless communication standards like e.g. 3GPP LTE expose the same kind of asymmetry with respect to MIMO requirements for downlink and uplink as a consequence of assuming that asymmetric traffic prevails and also as consequence of cost, size, complexity and battery power constraints due to which a smaller number of transmitters as to number of receivers is foreseen in a mobile terminal. For many applications at a client device, data flow in one direction is considerably greater in the downlink direction than in the uplink direction and therefore the antenna system supports the main requirements of a terminal.

One practical example of such a DL-MIMO operation is for a 3GPP's LTE low band wireless terminal co-operating with GSM900. The mode with the largest bandwidth supports LTE low band DL & UL band grouped with GSM900 DL & UL band. The mode with the smallest bandwidth is only assigned to LTE low band DL.

In another embodiment of the invention, the wireless antenna system has more than two feed ports, and supports more than two orthogonal radiation modes. This can be stated as an antenna system supporting N orthogonal radiation modes and comprising N feed ports for connecting to transmit and/or receive circuitry of the terminal (where N≧2). A first subset of the feed ports is assigned to a downlink frequency band and a second subset of the feed ports is assigned to an uplink frequency band. Circuitry is arranged to map the N radiation modes to the N feed ports, wherein the first subset of feed ports and the second subset of feed ports have at each least one port, and no more than N−1 ports, in common.

A further object of the present invention is to have revealed these radiation modes at the external feed ports of the antenna system. The circuitry materializing these appearances is the Mode Decomposition Network (MDN). Said differently the MDN is used to retrieve these radiation modes from the received signals. MDN provides the N orthogonal radiation modes made accessible at the N external frontend ports to the transmit/receive circuitry of the terminal. In case of a symmetric 2-port MIMO antenna system, whose radiation modes are the common mode and the differential mode, respectively, a common mode feed port and a differential mode feed port are provided by the MDN. Variants of the approach may comprise to deliver other desired superpositions of the radiation modes at the external feed ports.

### BRIEF DESCRIPTION OF THE DRAWINGS

Embodiments of the invention will be described, by way of example only, with reference to the accompanying drawings in which:

FIG. 1 shows an antenna system according to an embodiment of the invention;

FIG. 2 shows the antenna system in more detail;

FIG. 3 shows an antenna structure;

FIG. 4 show currents on the antenna elements for the different operating modes;

FIGS. 5A and 5B show operating modes of the antenna system;

FIGS. 6A and 6B show bandwidths of the antenna system for the operating modes;

FIGS. 7A to 9 show arrangements of circuitry for connecting antenna elements to transmit/receive circuitry of the terminal;

FIGS. 10A and 10B are illustrative and show alternative positioning of antenna elements on a ground plane;

FIG. 11 shows the possible implementation of an RF subsystem in detail.

### DETAILED DESCRIPTION OF AN EMBODIMENT

In the following detailed description of the preferred embodiments, reference is made to the accompanying drawings, which form a part hereof, and within which are shown by way of illustration specific embodiments by which the invention may be practiced. The drawings described are only schematic and are non-limiting. In the drawings, the size of some of the elements may be exaggerated and not drawn on scale for illustrative purposes. Those skilled in the art will recognize that other embodiments may be utilized and structural changes may be made without departing from the scope of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B. The term “network mode” and “radiation mode” coincide nearly for antennas with small dissipation. We refer to an antenna as self-matched if a sufficient level of TMRL is provided at the ports of the antenna physical structure without need for an external matching circuit. The “antenna physical structure” means an antenna without matching network or other circuitry. Generally the term “antenna system” refers to an “antenna physical structure” with additional circuitry such as a matching network (MMN) and/or MDN. It can represent a complete antenna system with “external ports”.

FIG. 1 shows a terminal 2 with an antenna system 20 according to an embodiment of the present invention. The terminal 2 can be a device such as a mobile phone, a mobile (or fixed) wireless computing device, a tracking device (e.g. for a vehicle, a container or parcel) or any other device which needs to send and/or receive wireless signals. The antenna system 20 can be provided as an integral part of the terminal 2, such as a card or circuit board forming part of the terminal 2. The antenna system may be used for a modem, a wireless access point, a router, in a computer, PDA, smartphone, tablet etc. Alternatively, antenna system 20 can be provided as part of a peripheral module 5 which can be plugged into the terminal, such as a dongle, Universal Serial Bus (USB) stick or card. In the case where the antenna system 20 forms part of a peripheral module 5, transmit/receive circuitry 10 is typically provided as part of the module 5 and an interface (e.g. USB) carries data to/from the host terminal 2. A connector 15 of the module 5 plugs into the host terminal 2. The antenna system may be used for a module being a modem, a wireless access point or similar.

Transmit/receive circuitry 10 comprises at least one transmitter 11 and at least one receiver 12. Transmit/receive circuitry which supports multiple input-multiple output (MIMO) operation on the downlink has multiple receivers 12, as shown in FIG. 1. Transmit/receive circuitry which supports multiple input-multiple output (MIMO) operation on the uplink has multiple transmitters 11. The transmit/receive circuitry 10 comprises circuitry for modulating one or more RF carriers with data and circuitry for demodulating one or more RF carriers. The transmit/receive circuitry 10 can also comprise circuitry for coding or decoding data. As the transmit/receive circuitry is conventional, it will not be described further. For MIMO operation, data is send/received on multiple paths, each path being terminated by one of the TX/RX circuits 11, 12 and a processor (being part of component 13) distributes data to the TX/RX circuits in a known manner. Other parts of the terminal are not shown in FIG. 1 for clarity.

FIG. 2 shows the antenna system 20 in more detail. Antenna system 20 comprises an antenna structure 25 having a plurality of antenna elements 21 (two antenna elements 21A, 21B are shown in FIG. 2). Each antenna element 21 connects to a respective internal port 22. Circuitry 30 contains the MDN and provides functions such as impedance matching of the antenna elements to the load (transmitter 11 or receiver 12). Circuitry 30 has a set of ports 31, 32 for connecting to transmitter 11 and receivers 12. These ports 31, 32 will be called frontend ports, or feed ports. The port 32 is connected to both the receive (RX) and the transmit (TX) paths and can be implemented at least in part by a duplexer or duplexer means 14A or, in case of TDD mode, by a RX/TX switch 14B.

FIG. 3 shows an example antenna structure 25 for an antenna system 20. A first antenna element 21A and a second antenna element 21B are arranged symmetrically about plane of symmetry passing through a line 23. Each antenna element is connected to a respective internal port on a substrate 24. This will be described as geometrically symmetric two-port antenna structure.

As described above, the antenna system 20 can be provided as an integral part of a terminal or it can be provided as a module 20 which is plugged or soldered in to the terminal as required. Especially when being part of a plug-in module 5, the physical space available for the antenna structure 25 is very limited. For example, the external dimensions of a module 5 (e.g. when implemented in a typical USB stick) can be approximately 80 mm long by 30 mm wide by 15 mm deep and the operating frequency can be 698 MHz-960 MHz. Whether it is a module 5 or 20 the module dimensions are a function of the available ground, whether extended or not through a USB or other solid ground connector, the bandwidth and the requested centre frequency.

In the example of FIG. 2, the antenna elements 21A, 21B are smaller than would ideally be required for operation across a wide frequency band and the antenna elements are spaced very closely together.

An antenna structure, of the type shown in FIG. 3, has two orthogonal radiation modes and corresponding network modes for all frequencies. Topologically, the antenna structure looks like a dipole antenna, but it is operated in two different ways. FIG. 4 shows two operating modes of an embodiment of the invention.

Referring to FIG. 4, this shows the antenna elements 21A, 21B. Currents on a symmetric two-port antenna can be represented as superpositions of common mode and differential mode. Common and differential modes have orthogonal patterns and are not correlated (Rayleigh environment). In the common mode, the two antenna ports are fed with a pair of signals (one per port) which are of equal amplitude and phase. In the differential mode, the two antenna ports are fed with a pair of signals (one per port) which are of equal amplitude but offset in phase by 180°. Operating modes of a MIMO antenna are the effect of superpositions of these two modes, common and differential. Eventual correlation between ports depends on the carrying out of these superpositions.

The overall MIMO antenna bandwidth will be governed by the mode (differential or common) with the smaller bandwidth. A Mode Decomposition Network (MDN) 50, shown in FIG. 7A, retrieves e.g. the (signals representing the) radiation modes from the received signals. These radiation modes may have different or equal bandwidths again.

In case of a two-port antenna, the received/transmitted signals can always be decomposed into common and differential mode. But only if the antenna structure is symmetric (with respect to its internal ports) do the latter modes coincide with the radiation modes.

FIG. 5 shows the role of the mode decomposition network in 30 for the case of a symmetric two-port antenna where the differential mode is made accessible at port 31 and the common mode is made accessible at port 32. FIG. 5A illustrates how the antenna structure 25 is used as a dipole antenna, with the antenna elements 21A, 21B operated in differential mode which is made accessible at frontend port 31 and connected to a receiver circuitry. The intrinsic and matched bandwidth of this mode is typically narrow as a result of typical size constraints in device design.

FIG. 5B shows how the antenna structure 25 is at the same time used as a pair of monopole antennas, with the antenna elements 21A, 21B operated in a common mode and coupled to frontend port 32. The matched bandwidth in this mode is typically wider than that of the differential mode. Port 32 is connected to both a receive (RX) and transmit (TX) path. The connection can be implemented at least in part by a duplexer or duplexer means 14A or, in case of TDD transmission, by a RX/TX switch 14B.

The proposed method of operation can be used to simultaneously achieve MIMO operation in one transmission direction and single antenna operation in the other. For example, MIMO operation in the downlink direction (DL), known as DL-MIMO, can be performed using simultaneously the differential mode A and the common mode Σ to realize two-antenna DL-MIMO while, at the same time, transmitting in the uplink direction using only the common mode Σ having the wider bandwidth. Alternatively, MIMO operation in the uplink direction (UL), known as UL-MIMO, can be performed using simultaneously the differential mode and the common mode while, at the same time, receiving in the downlink direction using only the common mode having the wider bandwidth.

A wireless terminal is typically required to operate across a band of frequencies. In a Frequency Division Duplex (FDD) transmission scheme, one part of the frequency band will be allocated to uplink transmissions (UL) and a different part of the frequency band will be allocated to downlink transmissions (DL). FIGS. 6A and 6B also show bandwidth responses of an example antenna system 20. FIG. 6A shows example allocations of a frequency band for uplink transmissions 41 and downlink transmissions 42. The common mode Σ bandwidth 44 (e.g. seen at port 32) is wide enough to cover both Uplink (UL) 41 and DL 42 simultaneously. The narrow differential mode A bandwidth 43 of the dipole arrangement of antenna elements 21A, 21B (seen at port 31) is limited only to cover DL. This solution provides relaxed requirements for the differential mode A bandwidth 43 of the antenna system 20 (a narrow bandwidth seen at port 31 is enough for DL) while still maintaining support for MIMO operation in DL (signals are received on both ports). At the same time the antenna system is capable of operating in the transmit mode in UL as a “single antenna” system (signals transmitted on port 32 only).

The scheme shown in FIG. 7A is suited to DL-MIMO, i.e. where a wireless terminal is required to receive two independent signals by receiving in the first radiation mode as well in the second mode on antenna elements 21A, 21B. The different (orthogonal) responses of the antenna system provide two independent signals at the receiver in the downlink. It will be understood that the scheme could alternatively be applied to UL MIMO, i.e. where a wireless terminal is required to transmit two independent signals by transmitting in the first mode as well as in the second mode on antenna elements 21A, 21B. For UL-MIMO the response of the radiation mode with smallest bandwidth is aligned with the band used for uplink transmissions.

The circuitry MMN (33, FIG. 7A) is a matching circuitry. It entails that each subset of modes should be matched according to TMRL, but restricted to the respective subset and for the respective portion of the band, at the internal ports 26. Specifically in the embodiment of the 2-port symmetric antenna the procedure of TMRL to the common mode coincides with the application of modal return loss. At the frontend port 32 it turns to the optimizing of RL in the e.g. UL bandwidth.

The circuitry MDN (50, FIG. 7A) reveals at the corresponding frontend port the common and differential mode, being attributes to the physical antenna. It decomposes these from the radiation patterns received and processed by the MMN. The frontend port signal 31 or 32 represents respectively the differential and common mode. As the grouping of the common mode and differential mode as first is matched over the DL frequency band, where as second only the common mode is matched over the UL frequency band, the frontend port assigned to the common mode shall support the collection of each of these bands being the DL and UL band, where the other ‘differential’ frontend port shall support only the DL band. At both frontend ports the signals from the DL band are orthogonal. It is a prerequisite for DL-MIMO.

Mutatis mutandis there is an UL-MIMO implementation of the MMN and MDN circuitries on the model of the DL-MIMO above.

In one embodiment, the physical antenna structure already provides some or all sets of radiation modes matched over its respective portion of the frequency band, or is self-matched, therefore the mode matching network MMN 33 will be concretized as only feed-throughs 28, or the internal ports 22 coincide with the matched ports 26.

Advantageously, the Mode Matching (Hermitian match) is performed first (on an airwave signal), before Mode Decomposition to minimize energy losses in resistive elements used in the MDN and further down the signal path.

Three embodiments of circuitry 30 of the antenna system 20 are shown in FIGS. 7-9. FIG. 7A shows a general schematic representation of a two-port antenna 21A, 21B connected to a Mode Matching Network (MMN) 33 and to a Mode Decomposition Network (MDN) 50. The MMN 33 is positioned nearest the antenna structure 25, in between the antenna structure 25 and the MDN 50. This positioning is advantageous to minimise losses. At first the modes of the antenna structure 25 are matched by the MMN 33 and only then the MDN 50 is used to separate antenna modes.

Referring to FIG. 7A, and in the special case of a two-port antenna structure, and working from left to right across the Figure, on the air interface there is a two-port antenna structure with unmatched internal ports 22; matched ports 26; matched uncorrelated frontend ports, one DL & UL 32, the other DL 31. Also in this case, the port 32 is connected to both the receive (RX) and the transmit (TX) paths and can be implemented at least in part by a duplexer or duplexer means 14A or, in case of TDD transmission, by a RX/TX switch (14B, FIG. 7B).

MMN 33 and MDN 50 can be implemented using technologies such as microstrip, discrete components, Low Temperature Co-fired Ceramic (LTCC).

The MDN 50 can be realised as a centre-tapped balun transformer or as a 180° hybrid coupler. In an embodiment shown in FIG. 7C, circuitry 30 is constructed as the centre-tapped balun transformer 51. It has a frontend port 32 and a Port 31 which are both unbalanced. The system uses both ports 31, 32 in the receive mode (RX) and a single port 32 in the transmit mode (TX). In FIG. 7D a balanced balun transformer 52 is useful if the further terminal circuitry applies a balanced RX filter and receiver input. The 180° hybrid coupler can be constructed directly or using 90° hybrid coupler with additional 90° line.

In one embodiment this antenna system comprises a set of 2 antenna elements for which the 2 radiation modes are intrinsically matched and orthogonal. However the radiation modes are calculated, not immediately measurable (in the reciprocal case of excitation), unless a Mode Matching Network (MMN) located between antenna and MDN is applied. The circuitry 30 maps/reveals the 2 orthogonal radiation modes uncorrelated at the 2 external feed ports of the antenna system.

In the approach presented in FIGS. 8 and 9 the designs take advantage of the geometric symmetry of the antenna. This approach separates the common mode matching network 35 and the differential mode matching network 36. The two antenna elements are connected together through a centre-tapped inductance (37, FIG. 8) or a centre-tapped transformer (39, FIG. 9). The common mode node 27 is connected to the common mode matching network (ΣMN) and internal ports 22 are connected to the differential mode matching network (ΔMN) 36. At its output a balun transformer 38 or a differential receiver input is used to suppress the common mode at the output of the differential mode matching network (ΔMN) 36. An advantage of this approach is that the matching networks can be tuned separately for each mode. Also a much more complicated and difficult to acquire broadband 180° hybrid coupler (used in the previous sample) is replaced with a more easily available balun transformer.

FIGS. 10A and 10B show two alternative arrangements of antenna elements with respect to a ground plane/chassis 24. In FIG. 10A antenna elements 21A, 21B are positioned on opposing short edges of the chassis 24, symmetrically about symmetry plane 23. In FIG. 10B antenna elements 21A, 21B are positioned on the same longer edge of the chassis 24, symmetrically about symmetry plane 23.

Embodiments of the present invention can be described as a two-port antenna system supporting two radiation modes, where a first subset of radiation modes is assigned only to either DL or UL frequency band and used only for either DL reception or UL transmission, respectively, and a second subset of the radiation modes is assigned to both DL and UL frequency bands simultaneously.

Advantageously, the antenna system has geometric symmetry, with the antenna elements and common mode matching network connected through a centre-tapped inductance and two symmetric antenna ports are connected to a differential mode matching network.

Advantageously, any of the described antenna systems support multi-band operation.

Embodiments with More Than Two Ports

The antenna system has an advantage of providing radiation pattern diversity and polarization selectivity, radiation modes which can allow effective multiple port MIMO operation over a frequency band.

The embodiment described above is suited to situations where the antenna system must be housed on a device with a small form-factor, such as a plug-in module. The principles described above can be applied to systems with more than two ports. The number of possible combinations of receivers and transmitters for each frontend port increases with the number of ports.

In the case of a N port antenna, DL-MIMO is achieved if and only if at least 2 radiation modes are matched over the same DL band and these modes further made accessible at the external frontend ports by the MDN. Said differently, DL-MIMO is achieved if at least 2 frontend ports are matched within the DL portion of a band. For instance in the same case above having been applied DL-MIMO, the DL-MIMO doesn't exclude to have MIMO UL or DL in any other band of the spectrum. The only prerequisite is to find 2 modes out of N, which have been matched over that particular band and further made accessible by the MDN.

In an overview table N×N one would find all the required bands UL and all DL in the different rows and the N serviceable radiation modes allocated to the columns. If the N port antenna features an M-antenna-MIMO in band x the corresponding row x would show a subset of M and only M radiation modes selected. If only one single antenna system (SISO) is needed for a particular band UL either DL only one and only one entry point in the table will be selected. Per either row, referring to one particular band the complete group of selections characterizes one subset of serviceable modes.

In general, the idea behind the introduction of MIMO (DL and UL) is that with N antennas expectation is that it is possible to realise MIMO transmission and reception using N antennas. Usually it assumes it is possible to match collectively all of them for both UL and DL portion of a band. The MIMO antenna system then offers multiple matched ports 26. It assumes that the resulting bandwidth is sufficient for normal operations, but it is not. However, in reality, with small-volume devices it is possible to match first few radiation modes for both UL and DL. In order to exploit all the other radiation modes which feature narrow bandwidth they are matched only for the DL portion of a band.

Hence, a further aspect of the invention provides an antenna system, method comprising: generation of N orthogonal radiation modes being 1-to-1 mapped to N separate external feed ports, of which a first subset of the ports is assigned to the Downlink (DL) frequency band and used for DL reception and a second subset of the ports is assigned to the Uplink (UL) frequency band and used for UL transmission, wherein the two subsets of the ports have at least one port in common. This means that at least one of the radiation modes is used for both DL and UL. Advantageously, the subsets have N−1 ports in common.

Assigning means the subset of modes under consideration get matched to a particular frequency band by means of a MMN circuitry build according the TMRL criterion.

Advantageously, the implemented mode matching network MMN consists of only one circuitry for which a first subset of radiation modes satisfies a first matching criterion over a first portion of a frequency band and all next subsets of radiation modes satisfy each a different matching criterion, over each a different portion of a frequency band, wherein each subset has been composed as an autonomous set of the at hand N radiation modes.

Advantageously, the introduction of the MDN subsequent to the MMN allows having matched ports, each matched for only a particular selected portion of the frequency band rather than for all portions together of the frequency band requested. Without MDN the matching criterion in the MMN would be applied on all portions of the frequency band concurrently. The MDN reveals again the uncorrelated signals on the external feed ports, further connected to the transmit/receive circuitry.

Advantageously, the N radiation modes of the antenna system are intrinsically matched. However the radiation modes are calculated, not immediately measurable (in the reciprocal case of excitation), unless a Mode Matching Network (MMN) located between antenna and MDN is applied.

A further aspect of the invention provides a two or more port antenna system supporting two or more radiation modes, where a first of radiation modes is assigned only to DL or UL frequency band and used for DL reception or UL transmission and a second of the radiation modes is assigned to both DL and UL frequency bands simultaneously.

The circuitry MDN reveals at all of the N frontend ports, all N orthogonal radiation modes, a feature of the physical antenna. It decomposes these from the N radiation patterns received and processed by the MMN. Each frontend port signal represents a unique radiation mode. As each selected but autonomous subset of modes is matched over a number of frequency bands and consequently each mode out of that subset is supporting these indicated bands, each frontend port representing a particular mode shall support the collection of each of these bands taken of all subsets to which the mode is belonging to. At the frontend ports the signals from a particular band occurring twice or more are orthogonal. It is a prerequisite for MIMO.

Advantageously, the Mode Matching (Hermitian match) is performed first (on an airwave signal), before Mode Decomposition to minimize energy losses in resistive elements used in the MDN and further down the signal path.

Advantageously, the MDN is realized as a network that comprises 180° hybrids with equal or unequal power split or a center-tapped balun transformer.

In another embodiment of the invention a subset of effectively connected external feed ports is smaller than the number of orthogonal radiation modes out of the corresponding subset. The effectively selected and applied external feed ports are those corresponding modes which are chosen either by the transmit/receive circuitry or by user interaction.

Advantageously, any of the described antenna systems support multi-band operation.

Also in these embodiments the MDN can be designed using a modification of the algorithm presented in W. P. Geren, C. E. Curry, and J. Andersen, “A practical technique for designing multiport coupling networks,” IEEE Transactions on Microwave Theory and Techniques, vol. 44, no. 3, pp. 364-371, March 1996 with respect to unitary N×N matrix V composed of the eigenvectors of the radiation matrix of the physical antenna structure or of the physical antenna structure together with the MMN. The definition of the radiation matrix can be found e.g. in A. Krewski, W. Schroeder and K. Solbach, “Bandwidth Limitations and Optimum Low-band LTE MIMO Antenna Placement in Mobile Terminals Using Modal Analysis,” European Conference on Antenna and Propagation (EuCAP), Rome, Italy. 2011. The 2N×2N scattering matrix of the MDN is selected to contain along its anti-diagonal the block matrices V in the upper right and its transpose, respectively, in the lower left positions and zero otherwise. The matrix V is decomposed into an product of Givens rotations from which the topology and elements of MDN are directly obtained. In this case the MDN maps each radiation mode of the antenna arrangement to a separate external feed port. Variants of the approach may comprise to deliver other desired superpositions of the radiation modes at the external feed ports.

In another aspect the present invention provides a terminal which includes a wireless antenna system according to any of the embodiments of the invention described above as well as transmit circuitry; and receive circuitry.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-55. (canceled)

56. A wireless antenna system for a terminal comprising:
an antenna structure;
a first feed port for connecting to transmit and/or receive circuitry of the terminal;
a second feed port for connecting to transmit and/or receive circuitry of the terminal;
circuitry arranged to connect the antenna structure to the first feed port and the second feed port;
wherein the antenna system is operable in a first radiation mode and a second radiation mode, wherein the modes are orthogonal,
and wherein the circuitry is arranged to map the first feed port to the antenna structure for the first radiation mode across a first frequency band having a bandwidth which covers one of an uplink frequency band of the terminal's transmit circuitry or a downlink frequency band of the terminal's receive circuitry,
and the circuitry is arranged to map the second feed port to the antenna structure for the second radiation mode across a second frequency band, wherein the second frequency band covers both of an uplink frequency band of the transmit circuitry and a downlink frequency band of the receive circuitry.

57. The wireless antenna system according to claim 56, wherein the first radiation mode and the second radiation mode are matched, in accordance with a Total Multi-port Return Loss criterion.

58. The wireless antenna system according to claim 56, wherein one of the radiation modes satisfies a first matching criterion, preferably in accordance with a Total Multi-port Return Loss criterion over a first portion of a frequency band and the set of all radiation modes together satisfies a second matching criterion, in accordance with a Total Multi-port Return Loss criterion different than said first matching criterion over a second portion of a frequency band.

59. The wireless antenna system according to claim 56, wherein one of the radiation modes satisfies a first matching criterion, in accordance with a Total Multi-port Return Loss criterion over a first portion of a frequency band and the other one of the radiation modes satisfies a second matching criterion, in accordance with a Total Multi-port Return Loss criterion, different than said first matching criterion over a second portion of a frequency band.

60. The wireless antenna system in accordance with claim 58 or 59, wherein said second portion being different from said first portion.

61. The wireless antenna system according to claim 56, wherein the first radiation mode is a differential mode and the second radiation mode is a common mode.

62. The wireless antenna system according to claim 56 wherein the circuitry comprises a mode matching network and a mode decomposition network.

63. The wireless antenna system according to claim 56 wherein the circuitry comprises per mode a separate mode matching network and/or a separate mode decomposition network.

64. The wireless antenna system according to claim 62 or 63 wherein the mode matching network(s) is (are) positioned between the antenna structure and the mode decomposition network(s).

65. The wireless antenna system according to claim 56, wherein the transmit/receive circuitry supports multiple in-multiple out (MIMO) operation.

66. The wireless antenna system according to claim 56, wherein the antenna system supports N orthogonal radiation modes, comprising:
M feed ports for connecting to transmit and/or receive circuitry of the terminal (where M≧2), wherein at least a first subset of the feed ports are assigned to a downlink frequency band and at least a second subset of the feed ports are assigned to an uplink frequency band; and
circuitry arranged to map the N radiation modes to the M feed ports, wherein the first subset of feed ports and the second subset of feed ports have at least one port, and no more than M−1 ports, in common.

67. The wireless antenna system according claim 56, wherein a first subset of radiation modes satisfies a first matching criterion, in accordance with a Total Multi-port Return Loss criterion over a first portion of a frequency band and a second subset of radiation modes satisfies a second matching criterion, in accordance with a Total Multi-port Return Loss criterion, different than said first matching criterion over a second portion of a frequency band, and the two subsets have at least one radiation mode in common.

68. The wireless antenna system according to claim 66 or 67, wherein all the radiation modes are matched, in accordance with a Total Multi-port Return Loss criterion.

69. A method of operating a wireless antenna system for a terminal comprising an antenna structure, a first feed port for connecting to transmit and/or receive circuitry of the terminal, a second feed port for connecting to transmit and/or receive circuitry of the terminal and circuitry arranged to connect the antenna structure to the first feed port and the second feed port, wherein the antenna system is operable in a first radiation mode and a second radiation mode, the modes having different responses wherein the modes are orthogonal, the method comprising:
mapping signals between the first feed port and the antenna structure for the first radiation mode across a first frequency band having a bandwidth which covers one of an uplink frequency band of the transmit circuitry and a downlink frequency band of the receive circuitry;
mapping signals between the second feed port and the antenna structure for the second radiation mode across a second frequency band, wherein the second frequency band covers both of an uplink frequency band of the transmit circuitry and a downlink frequency band of the receive circuitry.

70. The method of claim 69, wherein one of the radiation modes satisfies a first matching criterion in accordance with a Total Multi-port Return Loss criterion over a first portion of a frequency band and the other one of the radiation modes together satisfies a second matching criterion, in accordance with a Total Multi-port Return Loss criterion, different than said first matching criterion over a second portion of a frequency band.

71. An antenna system supporting N orthogonal radiation modes being mapped to N separate external feed ports, of which a first subset of the ports is assigned to the Downlink (DL) frequency band and used for DL reception and a second subset of the ports is assigned to the Uplink (UL) frequency band and used for UL transmission, wherein the two subsets of the ports have at least one port in common.

72. The antenna system of claim 71, wherein a first subset of radiation modes satisfies a first matching criterion, in accordance with a Total Multi-port Return Loss criterion, over a first portion of a frequency band and a second subset of radiation modes satisfies a second matching criterion, in accordance with a Total Multi-port Return Loss criterion, different than said first matching criterion over a second portion of a frequency band, the two subsets have at least one radiation mode in common.
